(19) United States
(12) Patent Application Publication
(10) Pub. No.: US 2006/0037198 A1
(43) Pub. Date: Feb. 23, 2006

(54) Portable device and method for cutting pipe or tubing

(76) Inventor: Kenneth F. Sullivan, Hatboro, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/207,248

(22) Filed: Aug. 19, 2005

Related U.S. Application Data
(60) Provisional application No. 60/602,615, filed on Aug. 19, 2004.

(51) Int. Cl. B26D 3/16; B23D 21/06

(52) U.S. Cl. 30/92

(57) ABSTRACT

A portable hand held device for cutting pipe or circular tubing rotates or turns by the force generated by a power drill or manually by hand. This portable hand held device for cutting pipe or circular tubing is generally circular in nature with a hinged door that opens allowing pipe or circular tubing to be inserted, and closes encasing the pipe or circular tubing inside. This device includes internal gears and an external housing with gears allowing a unit or part of the unit, including plastic or rubber rollers and a stationary cutting blade, to rotate or turn around the pipe or circular tubing. The plastic or rubber rollers support the pipe or circular tubing as the blade rotates about and cuts the pipe or tube. The rollers and cutting blade are preferably attached to an internal sidewall of the device.

### BACKGROUND OF THE INVENTION

1. Field of Invention

This invention relates to cutting tools, and in particular, to portable hand held pipe or tube cutters.

2. Description of Related Art

Pipe or circular tubing is used in construction for many purposes, and some of those uses include conduit for housing electrical wires, transporting water and providing drainage or expulsion of air or gas. Cutting pipe or circular tubing has either been done by using large heavy-duty machines with stationary bases or by using small manual hand held pipe cutting devices.

Portable hand held devices for cutting pipe or circular tubing have been powered manually. Known pipe cutters have been described in U.S. Pat. No. 3,449,992 (Hanaway); U.S. Pat. No. 5,142,825 (Floyd); U.S. Pat. No. 5,829,142 (Rieser); U.S. Pat. No. 5,943,778 (Alana); U.S. Pat. No. 6,189,216 (Dureiko); U.S. Pat. No. 6,357,119 (Acerra) and U.S. Pat. No. 6,581,499 (Myers). However, none of the known portable pipe cutters temporarily attach a drill bit to cut pipe or tubing.

All references cited herein are incorporated herein by reference in their entireties.

### BRIEF SUMMARY OF THE INVENTION

A portable device or cutter for cutting pipe or circular tubing is generally circular in nature with a hinged door that opens allowing a pipe or circular tube to be inserted and encased in the device. According to the preferred embodiments, as the portable hand held device's gears turn, a circular cutting blade cuts around and into the pipe or circular tubing while plastic or rubber rollers support the pipe or circular tubing. The portable hand held device for cutting pipe or circular tubing includes internal gears and an internal housing unit supported by bearings that rotate or turn by the force generated by a power drill, preferable with a standard rectangular or square bit. Alternatively, the portable hand held device can be rotated or turned by hand by rotating the device around the pipe or circular tubing.

The cutter in accordance with the preferred embodiments is designed so that pipe or circular tubing can be cut on a job site or almost anywhere faster, more easily and more efficiently. This cutter, when used in conjunction with a power drill, allows a pipe or circular tube to be cut in a manner other than a manual process. The cutter allows the user to cut pipe or circular tubing while the pipe or circular tubing is stationary, attached to wall, ceiling or other object or while being held by hand, secured in a vice or clamp.

The preferred cutter includes a circular device with a door or hinged opening that allows the pipe or circular tubing to be inserted and then enclosed in the device. A small latch secures the door to the case. The cutter has rubber or plastic rollers that support the pipe or circular tube against a cutting blade that cuts into the pipe or circular tube as the device rotates or turns. In particular, as the internal parts of the portable cutter rotate or turn, the cutting blade presses up against the pipe or circular tubing and cuts into the material of the pipe or tube as desired until the pipe or tube is cut all the way through. While not being limited to a particular theory, the preferred rubber or plastic rollers are supported by compression springs and can be adjusted for tension against the outer cylindrical wall of the pipe or circular tubing by a screw. The cutting blade is also adjustable and urged against the pipe or circular tubing by either spring tension or an external screw. Attached to the circular device on one side of the portable pipe cutter is an outer casting unit that houses a gear, which is turned by the rotating or spinning motion of a power drill. The gear in the external casing unit is paired up with a set of internal gears that rotate or turn an internal unit including the rollers and cutting blade. The internal unit is supported preferably by bearings that allow the unit to rotate inside the circular device.

The invention will be illustrated in more detail with reference to the following examples, but it should be understood that the present invention is not deemed to be limited thereto.

### BRIEF DESCRIPTION OF SEVERAL VIEWS OF THE DRAWINGS

The invention will be described in conjunction with the following drawings, in which like reference numerals designate like elements and wherein:

FIG. 1 is shows a three-quarter view of the portable pipe-cutting device in accordance with a preferred embodiment of the invention;

FIG. 2 shows a three-quarter partial view of the portable pipe-cutting device shown in FIG. 1;

FIG. 3 shows an open frontal view of the portable pipe-cutting device, with a front view of the cutting blade, and a side view of the unit which houses the cutting blade and a roller unit, in accordance with a preferred embodiment of the invention;

FIG. 4 shows a top view, partially in section, of the preferred portable pipe-cutting device and gears that turn internal rollers and the cutting blade;

FIG. 5 shows a top view, partially in section, of the preferred portable pipe-cutting device with an external housing unit and a door that pivots to allow a pipe or circular tubing to be inserted;

FIG. 6 shows a partially sectional top view of the portable pipe-cutting device with internal mechanism of an externally attached side housing unit and matching gears, in accordance with the preferred embodiments;

FIG. 7 shows a partially sectional top view of the portable pipe-cutting device of FIG. 5 with an internal mechanism of the externally attached side-housing unit, matching gears and the door assembly;

FIG. 8 shows a side view of the cutting assembly in accordance with the preferred embodiments;

FIG. 9 shows a sectional view of the cutting assembly shown in FIG. 8;

FIG. 10 shows a perspective view of a exemplary roller system used to support pipe and/or circular tubing;

FIG. 11 shows a front view of the portable pipe-cutting device in accordance with the preferred embodiments; and

FIG. 12 shows a side view of the portable pipe-cutting device, showing the external housing unit in accordance with the preferred embodiments.

### DETAILED DESCRIPTION OF PREFERRED EMBODIMENTS OF THE INVENTION

The portable pipe cutter can be used manually or with the aid of an external power source to cut pipe or circular tubing. The preferred method of use is to use the device in conjunction with a power drill. Because of the ease of use of this product, speed and the ways in which it can be used, manually or in conjunction with a power tool, professionals and lay people will want to use this device. The portable pipe cutter can be used while the pipe or circular tubing is attached or fixed or while the pipe or circular tubing is being held manually, laid down on a flat surface or secured by means of a vice or clamp. While not being limited to a particular theory, an external casing and exterior housing unit of the cutter do not need to rotate for the cutter to work. Instead, the internal parts of the device rotate to cause the necessary cutting action.

While not being limited to a particular theory, one exemplary approach for using this device is with a power drill is described below. For example, the portable pipe-cutting device is attached to a drill by inserting a square or rectangular drill bit into the hole of the external housing unit. The door of this device is opened up by using fingers or hands to unlock and open the door, putting the pipe or circular tubing inside the opening in a perpendicular position to the top flat surface of this device, and then closing and securing the door. While keeping the pipe or circular tubing stationary, the drill is turned on, causing the paired gears of the portable pipe-cutting device to rotate or turn the cutting blade and the rollers, which are attached to the internal bearing unit, around the pipe or circular tubing. This process is complete when the pipe or circular tubing is cut into two parts.

As noted above, the portable pipe-cutting device (or cutter) can also be used manually. For manual use, the pipe or tube is inserted within the device in the manner described above, that is, by unlocking and opening the door, inserting the pipe or tube inside the opening, closing the door about the tube or pipe, and then securing the door to the device. In order to manually cut the pipe, rotate the external casing around the pipe or tube to turn the cutting blade. This turning of the cutting blade about the pipe or tube causes the blade to cut the pipe or tube.

In use, the portable pipe-cutting device should be held in the right or left hand. With the opposite hand, or with the hand or fingers of another individual, the door of this device is opened, the pipe or circular tubing is placed inside the opening in a perpendicular position to the top surface of this device, and then the door is closed and secured by a small latch. While keeping the pipe or circular tubing stationary, the internal unit turns or rotates in a circular motion around the pipe or circular tubing to cut the pipe or tube. This process is complete when the pipe or circular tubing is cut into two parts.

It is understood that the approaches described above are preferred approaches for using the portable pipe cutter to cut a pipe or tube, and that the invention is not limited thereto. In fact, other approaches to using the portable pipe cutter are applicable as readily understood by a skilled artisan. Accordingly, the invention is not limited to any one approach, as the approaches and embodiments are preferred amongst numerous examples of the invention.

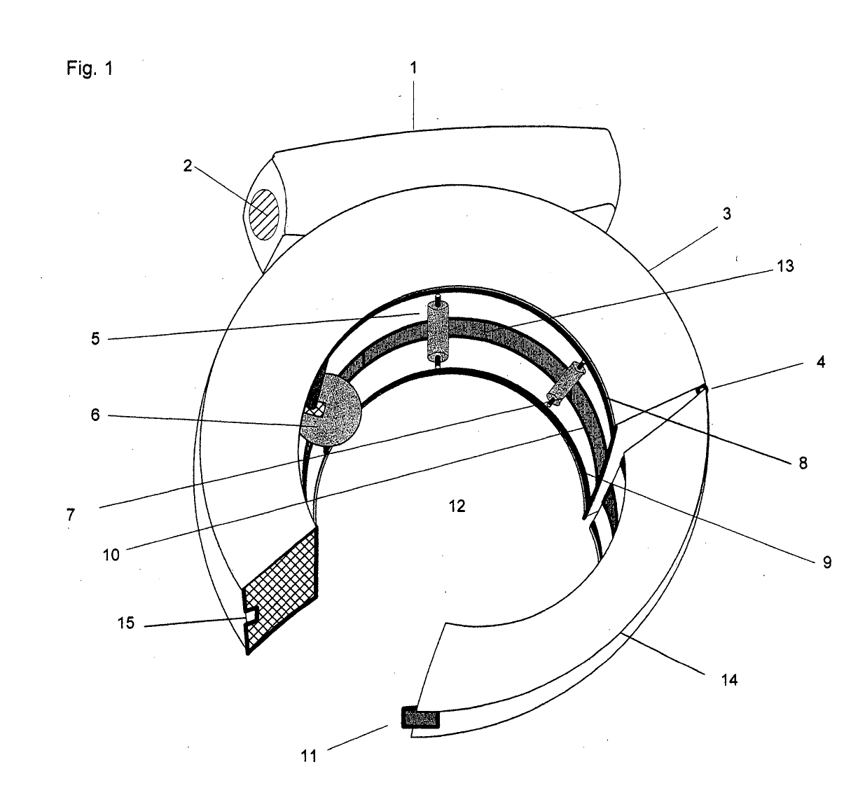

FIG. 1 shows the portable pipe-cutting device in a three-quarter front view. As seen in FIG. 1, an external housing unit 1 is attached to an external casing 3, which houses rollers 5 and a cutting blade 6, used for cutting a pipe or tube. A drill bit can be inserted into an aperture or opening 2 of the external housing unit 1 to activate the cutting. The external casing 3 is also a housing for an upper bearing unit 8, a lower bearing unit 9, and door 14, and a hinge on which the door 14 opens and shuts. A latch 11 attaches to latch mate 15 to keep the door 14 shut as desired, for example, when cutting a pipe inserted into the opening 2. One of the sectional units of the gears 13 is also shown in FIG. 1.

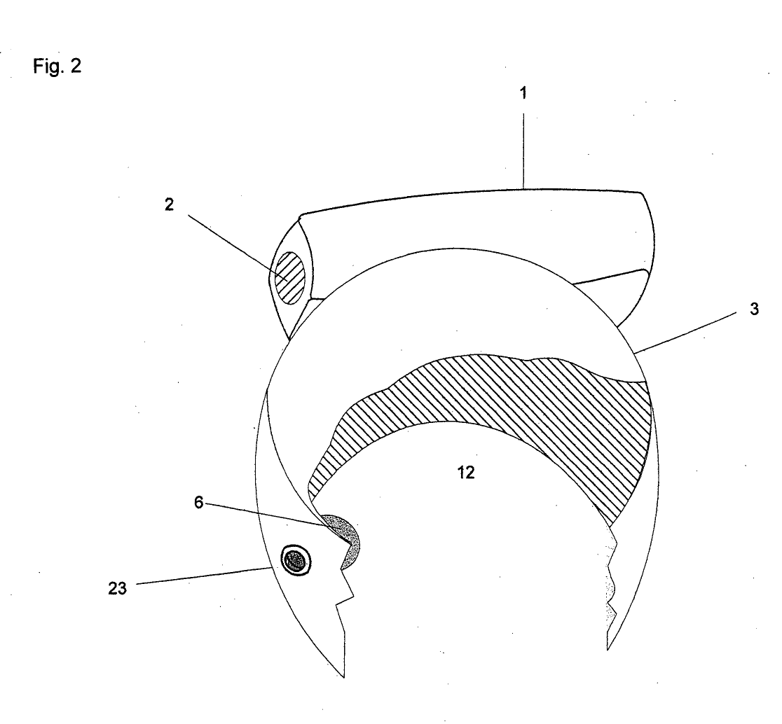

FIG. 2 shows the portable pipe-cutting device in a partial three-quarter front view. In particular, FIG. 2 shows the attached external housing unit 1, the opening 2 in which a drill bit can be inserted into the housing unit, the outer casing unit 3, and an adjusting screw 23 that adjusts the cutting blade 6, as will be described in greater detail below.

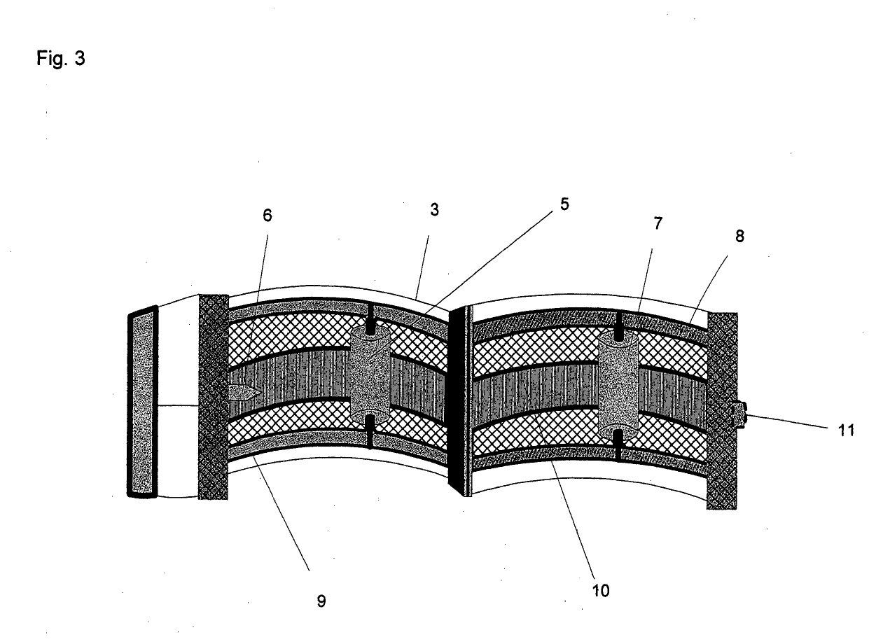

FIG. 3 shows a frontal view, partially in section, of the preferred portable pipe-cutting device. The outer casing 3 serves as a housing for the cutting blade 6, rollers 5, 7, the upper bearing unit 8, the lower bearing unit 9, and internal gears 10, which are described in greater detail below. FIG. 3 also shows the latch 11, which keeps the upper casing 3 closed when locked.

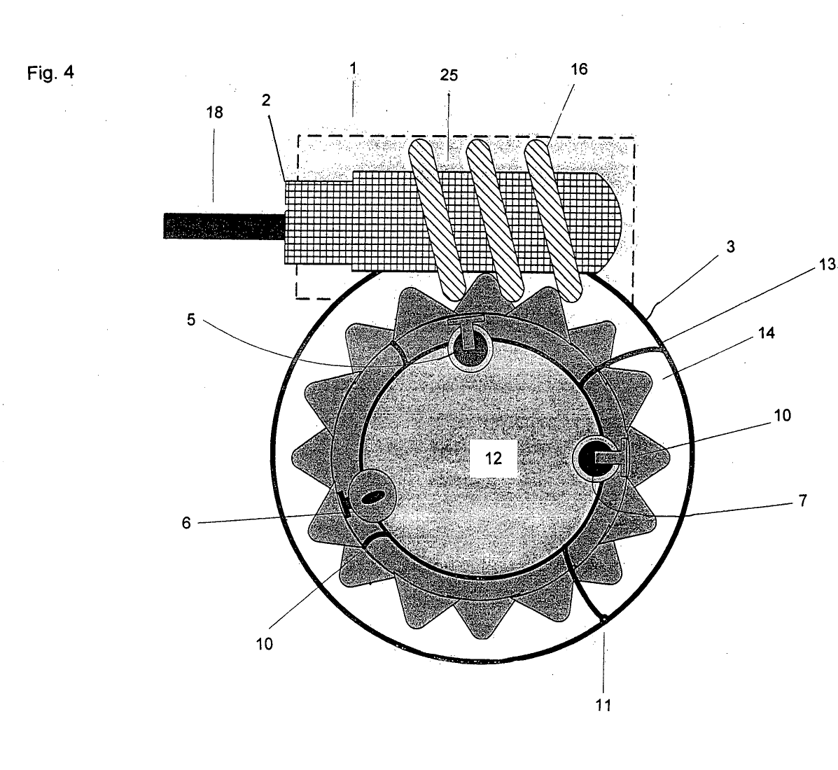

FIG. 4 shows a top view, partially in section, of the preferred portable pipe-cutting device (or cutter). A drill bit 18 engages a gear unit 25 at the opening 2 to cause a rotation of external gears 16 about the gear unit and within the external housing unit 1. Rotation of the external gear unit 16 actuates a rotation of internal gears 10 coupled between the external gears 16, and the roller 5, cutting blade 6, and roller 7. With the aid of the upper bearing unit 8 and the lower bearing unit 9, the turning of the internal gears 10 causes the cutting blade 6 and rollers 5, 7 to rotate within the external casing 3 and about a pipe or tube inserted into an opening 12 of the external casing.

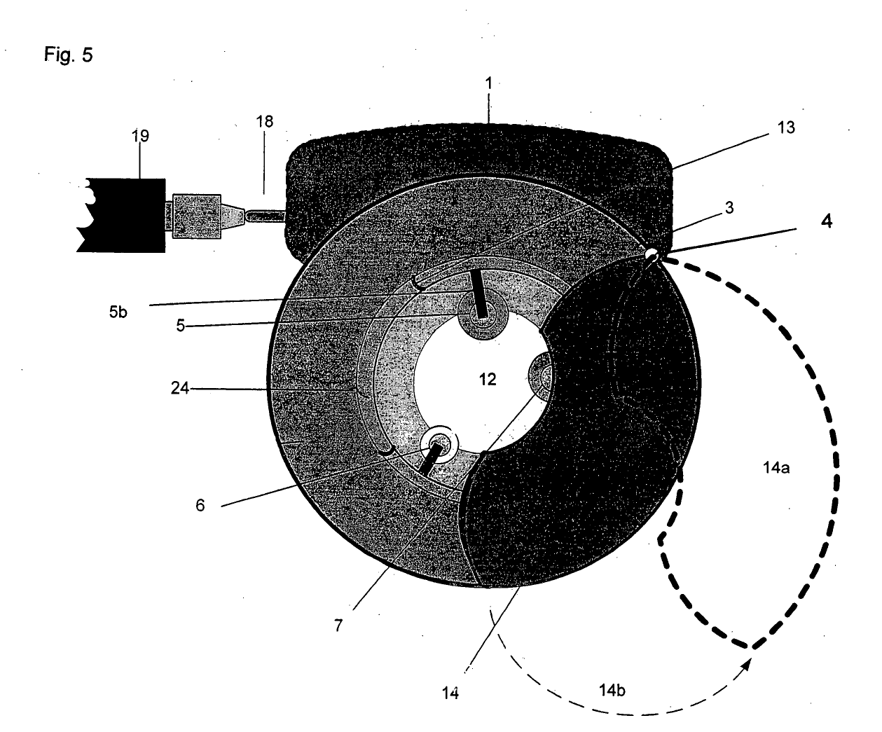

FIG. 5 shows a top view of the preferred pipe cutter to illustrate the manner in which the door 14 opens and closes. As can be seen in FIG. 5, the door 14 is shown in a closed position. The external casing 3 is adapted to accept a pipe or tube for cutting by opening the door 14, for example, along the dashed line 14B to an open position 14A.

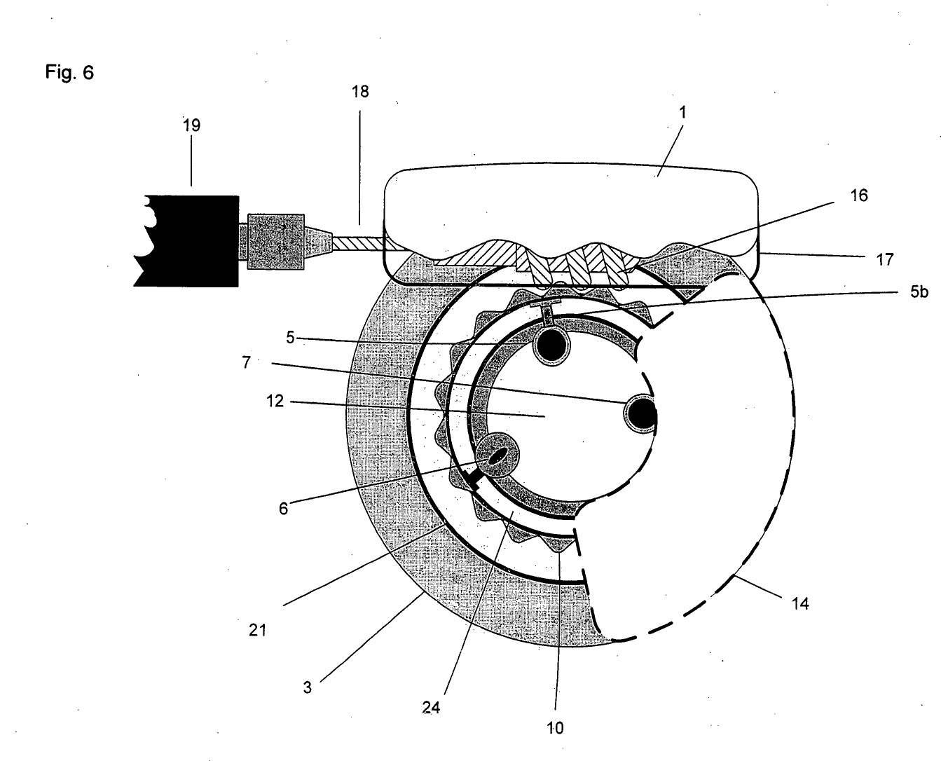

FIG. 6 shows a top view, partially in section, of the preferred portable pipe cutter, including the external casing 3 and the housing unit 1, but without the door 14. A drill bit 18 extends from a power drill 19 into the opening 2 of the housing unit 1 to activate and turn the gear unit 25 and its external gears 10. When rotated, the external gears 16 act upon and cause the internal gears 10 to rotate and spin the cutting blade and rollers 5, 7 about a pipe or tube located in the opening 12. A bearing unit 24 is shown on which the cutting blade 6 and rollers 5, 7 turn or rotate within the outer edge of the internal rotating mechanism 21.

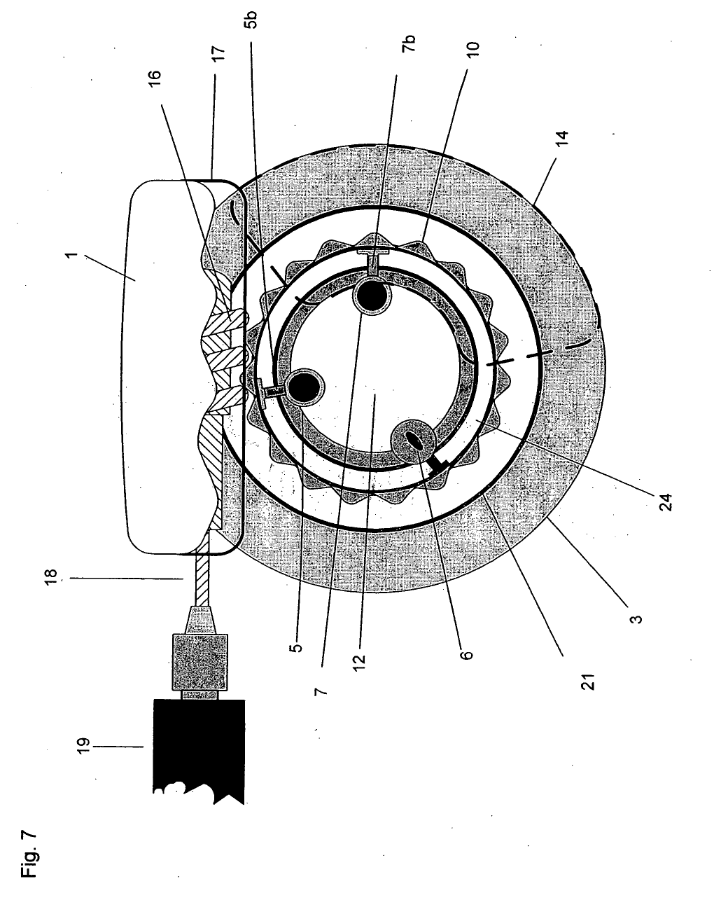

FIG. 7 is similar to FIG. 6, and shows the preferred pipe cutter of FIG. 6 with its door 14. As can be seen in FIG. 7, when the door 14 is closed, all of the internal gears 10 are aligned to interact between the external gears 16 and the cutting blade 6 and rollers 5, 7. That is, with the door 14 closed, the external gears 16 can continuously rotate causing the internal gears 10 to rotate, and in turn, rotate the rollers 5, 7 and the cutting blade 6 about a pipe or tube inserted in the opening 12, separating the pipe or tube as the cutting blade 6 cuts through the pipe or tube. In the exemplary embodiment shown in FIG. 7, a bearing unit 24 is located within an outer edge 21 of the internal rotating mechanism, on which the cutting blade 6 and the rollers 5, 7 turn or rotate. In this preferred embodiment, the rollers 5, 7 are coupled to the bearing unit 24 and the internal gears 10 via compression springs 5B, 7B, respectively, but keep the respective rollers 5, 7 against the pipe or tube inserted into the opening 12 for cutting.

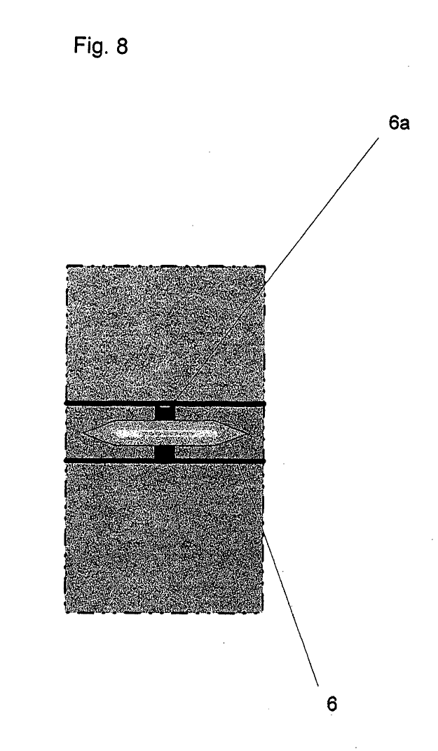

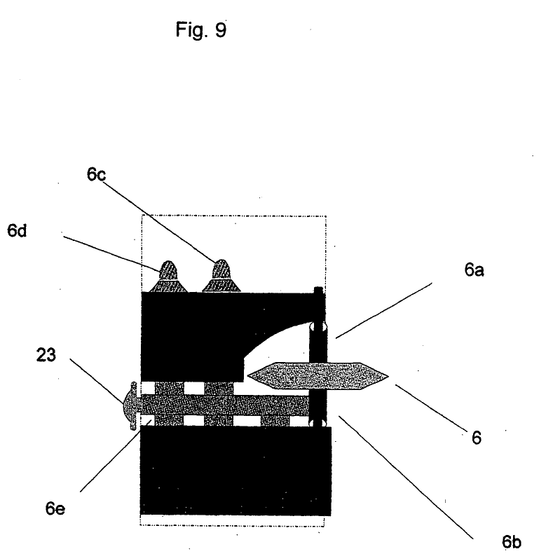

FIGS. 8 and 9 are front and side sectional views of cutting blade unit 26 in accordance with preferred embodiment of the invention. As can be best be seen in FIG. 9, the cutting blade unit 26 includes the cutting blade 6 connected along its axis to an axle 6A that is rotatably communicating with the cutting blade unit. The cutting blade unit 26 also includes an adjusting screw 23 threadingly engaged within an adjusting collar 6E. The collar 6E is in contact with the axle 6A, preferably at a lower portion 6B of the axle, to move the axle 6A and the cutting blade 6 via the adjusting screw 23. That is, the adjusting screw 23 and adjusting collar 6E, are adapted to move the cutting block axle 6A as needed for the cutting blade 6 to urge against and cut a pipe or tubing in the opening 12 in accordance with the preferred embodiments.

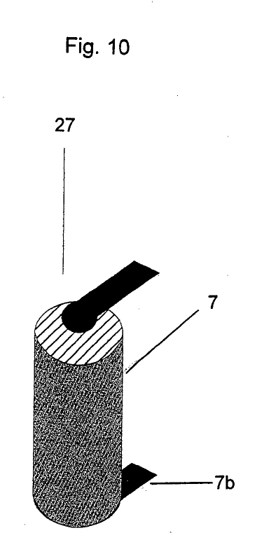

FIG. 10 is a perspective view of a roller unit 27 including the roller 7 and the roller spring 7B. It is understood that since the roller 5 and the roller 7 are substantially similar, the roller unit 27 could likewise include the roller 5 and spring 5B also shown in FIGS. 6 and 7.

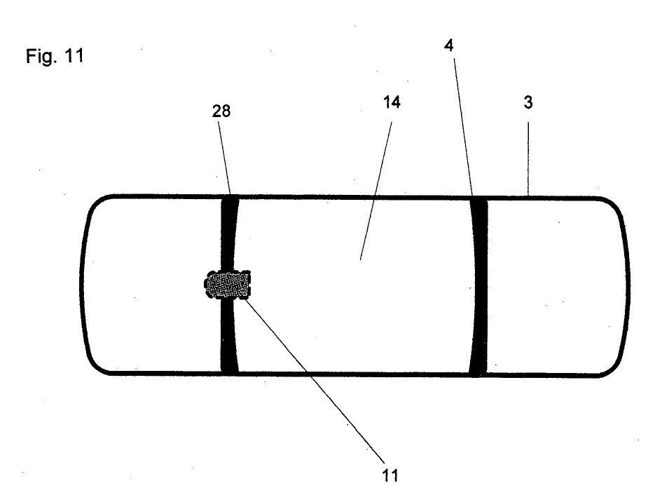

FIG. 11 shows a front view of the external casing in accordance with the preferred embodiments. As can be seen in FIG. 11, the outer casing 3 is shown with the door 14 in a closed position such that the latch 11 is coupled with the latch mate 15 and the latch covers the latch mate. As discussed above, the door 14 pivots on the door hinge 4 between an open position and a closed position, shown in FIG. 11, where the door engages with the outer casing 3 in a coupled relationship at the door opening 28.

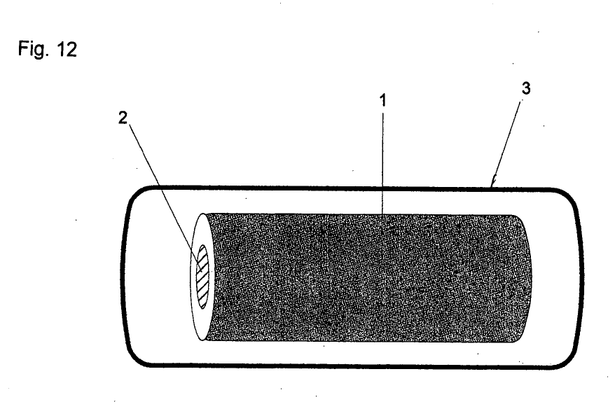

FIG. 12 shows a back view of the preferred portable pipe cutter. The external housing unit 1 includes an opening 2 adapted to accept a drill bit 18 for turning the external gears 16 that in turn cause the internal gears 10 in the external casing 3 to rotate and spin the cutting blade and rollers 5, 7 about a pipe or tube to cut the pipe. Preferably, the external casing 3 and external housing unit 1 are attached, and at least are in communication so that the external gears 16 and internal gears 10 can cooperate to rotate the cutting blade 6.

It is understood that the portable pipe-cutting device (or portable pipe cutter) method and apparatus described and shown are exemplary indications of preferred embodiments of the invention, and are given by way of illustration only. In other words, the concept of the present invention may be readily applied to a variety of preferred embodiments, including those disclosed herein. While the invention has been described in detail and with reference to specific examples thereof, it will be apparent to one skilled in the art that various changes and modifications can be made therein without departing from the spirit and scope thereof. For example, while the pipe cutter is preferably attached to a drill by fitting a square or rectangular drill bit into the opening of the external housing unit 1, it is understood that the scope of the invention is not limited to a square or rectangular drill bit, but is applicable to any shape or configuration that allows a drill bit to be matched with the opening of the external housing unit to rotate the external gears 16 of the gear unit 25. In addition, while the invention is described with reference to a cutter having one blade and two rollers, it is understood that other numbers (or shapes) of blades and rollers are useable within the scope of the invention. Without further elaboration the foregoing will so fully illustrate the invention that others may, by applying current or future knowledge, readily adapt the same for use under various conditions of service.

What is claimed is:

1. A portable pipe cutter, comprising
a housing having a first gear unit; and
a casing coupled the said housing, said casing including a door, a second gear unit and a cutting blade, said door moveable from an open position for accepting a tubular member to a closed position that encloses the tubular member within said casing, said second gear unit interactively coupled with said first gear unit to rotate upon a movement of said first gear unit, said second gear unit attached to said cutting blade to move said cutting blade about the tubular member and cut the tubular member.

2. The portable pipe cutter of claim 1, further comprising a roller attached to said second gear unit distal to said cutting blade, said roller adapted to support said portable pipe cutter against the enclosed tubular member.

3. The portable pipe cutter of claim 2, further comprising a spring attached between said roller and said second gear unit for urging said roller against the tubular member.

4. The portable pipe cutter of claim 1, said housing including an aperture for allowing an external motor access to said first gear unit to turn said first gear unit.

5. The portable pipe cutter of claim 4, said first gear unit including external gears spirally radially extending out from said first gear unit into a mated relationship with said second gear unit, said external gears adapted to turn from a rotational application from said external motor and cause said second gear unit to rotate within said casing and about the enclosed tubular member.

6. The portable pipe cutter of claim 5, wherein the external motor includes a power drill.

7. The portable pipe cutter of claim 6, wherein the external motor further includes a drill bit coupled between the drill and said first gear unit.

8. The portable pipe cutter of claim 1, wherein said second gear unit includes a first portion and a second portion, said door at least partially enclosing said first portion of said second gear unit, said first portion being separate from said second portion when said door is at the open position to accept the tubular member, and said first portion being integral with said second portion when said door is at the closed position.

9. The portable pipe cutter of claim 1, further comprising a screw in communication with said cutting blade for adjusting the location of said cutting blade in relation to the tubular member.

10. A method of cutting a tubular member with a pipe cutter having a housing and a casing attached to the housing, the method comprising:
opening a door of the casing;
inserting a tubular member by the door into the casing;
closing the door to lock the tubular member within the casing;
inserting a drill bit into the housing;
coupling the drill bit with a first gear unit; and
rotating the first gear unit via the drill bit, said rotating causing the second gear unit to rotate the cutting blade about the tubular member and cut the tubular member.

11. A drill attachment for cutting a tubular member, comprising:
a housing having a first gear unit; and
a casing coupled the said housing, said casing including a door, a second gear unit and a cutting blade, said door moveable from an open position for accepting a tubular member to a closed position that encloses the tubular member within said casing, said second gear unit interactively coupled with said first gear unit to rotate upon a movement of said first gear unit, said second gear unit attached to said cutting blade to move said cutting blade about the tubular member and cut the tubular member.

12. The drill attachment of claim 11, further comprising a roller attached to said second gear unit distal to said cutting blade, said roller adapted to support said drill attachment against the enclosed tubular member.

13. The drill attachment of claim 12, further comprising a spring attached between said roller and said second gear unit for urging said roller against the tubular member.

14. The drill attachment of claim 11, said housing including an aperture for allowing an external motor access to said first gear unit to turn said first gear unit.

15. The drill attachment of claim 14, said first gear unit including external gears spirally radially extending out from said first gear unit into a mated relationship with said second gear unit, said external gears adapted to turn from a rotational application from said external motor and cause said second gear unit to rotate within said casing and about the enclosed tubular member.

16. The drill attachment of claim 15, wherein the external motor includes a power drill.

17. The drill attachment of claim 16, wherein the external motor further includes a drill bit coupled between the drill and said first gear unit.

18. The drill attachment of claim 11, wherein said second gear unit includes a first portion and a second portion, said door at least partially enclosing said first portion of said second gear unit, said first portion being separate from said second portion when said door is at the open position to accept the tubular member, and said first portion being integral with said second portion when said door is at the closed position.

19. The drill attachment of claim 11, further comprising a screw in communication with said cutting blade for adjusting the location of said cutting blade in relation to the tubular member.
